(19) United States
(12) Patent Application Publication
(10) Pub. No.: US 2022/0135320 A1
(43) Pub. Date: May 5, 2022

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Toshiki KASHIWAKURA, Tokyo-to (JP); Yukiya Sugiyama, Toyota-shi (JP); Kano Asai, Okazaki-shi (JP); Hideo Hasegawa, Nagoya-shi (JP)

(73) Assignee: TOYOTA JIDOSHA KABUSHIKI KAISHA, Toyota-shi (JP)

(21) Appl. No.: 17/483,018

(22) Filed: Sep. 23, 2021

(30) Foreign Application Priority Data
Oct. 30, 2020 (JP) 2020-182184

(51) Int. Cl. B65F 1/14; G06Q 30/02; G06Q 10/08; G06K 19/07

(52) U.S. Cl. CPC B65F 1/1484; G06Q 30/0201; B65F 2210/128; G06K 19/0723; G06Q 10/087

(57) ABSTRACT

A sensor detects waste thrown into a trash can to obtain information about the waste, An information processing apparatus includes a controller configured to perform: obtaining information about a consumption behavior of a user from the information about the waste; and executing predetermined processing based on the information about the consumption behavior of the user. The information about the waste is information capable of identifying a first product corresponding to the waste, and the controller obtains, as the information about the consumption behavior of the user, a disposal amount of the waste corresponding to a first product, and makes, as the predetermined processing, an instruction to deliver the first product to a place corresponding to an installation place of the trash can when the disposal amount of the waste of the first product reaches a predetermined amount.

### CROSS REFERENCE TO THE RELATED APPLICATION

This application claims the benefit of Japanese Patent Application No. 2020-182184, filed on Oct. 30, 2020, which is hereby incorporated by reference herein in its entirety.

### BACKGROUND

### Technical Field

The present disclosure relates to an information processing apparatus, an information processing system, and an information processing method.

### Description of the Related Art

There has been disclosed a technique in which an RFID reader is provided in a trash can, so that identification information is read from an RFID included in an article discarded in the trash can to identify the discarded article (for example, Patent Literature 1).

### CITATION LIST

### Patent Literature

Patent Literature 1: Japanese Patent Application Laid-Open Publication No. 2006-248778

### SUMMARY

An aspect of the present disclosure has an object to provide an information processing apparatus, an information processing system and an information processing method which are capable of providing a service corresponding to a consumption behavior of a user.

One aspect of the present disclosure is directed to an information processing apparatus including a controller configured to perform:

obtaining information about waste that is obtained by a sensor configured to detect the waste thrown into a trash can;

obtaining information about a consumption behavior of a user from the information about the waste; and

executing predetermined processing based on the information about the consumption behavior of the user.

Another aspect of the present disclosure is directed to an information processing system comprising:

a sensor configured to detect waste thrown into a trash can;

an information processing apparatus including a controller configured to perform:

obtaining information about the waste obtained by the sensor;

obtaining information about a consumption behavior of a user from the information about the waste; and

executing predetermined processing based on the information about the consumption behavior of the user.

A further aspect of the present disclosure is directed to an information processing method comprising:

obtaining information about waste that is obtained by a sensor configured to detect the waste thrown into a trash can;

obtaining information about a consumption behavior of a user from the information about the waste; and

executing predetermined processing based on the information about the consumption behavior of the user.

According to the present disclosure, it is possible to provide a service corresponding to a consumption behavior of a user.

### BRIEF DESCRIPTION OF THE DRAWINGS

FIG. 1 is a view illustrating an example of a configuration of an automatic delivery system according to a first embodiment;

FIG. 2 is a diagram illustrating an example of a hardware configuration of a center server and a sensor device according to the first embodiment;

FIG. 3 is a diagram illustrating an example of a functional configuration of the center server;

FIG. 4 is an example of information stored in a user information database;

FIG. 5 is a diagram illustrating an example of information held in a waste information database;

FIG. 6 is an example of a flowchart of automatic delivery processing of the center server; and

FIG. 7 is an example of a flowchart of regular purchase proposal processing of the center server.

### DESCRIPTION OF THE EMBODIMENTS

An aspect of the present disclosure is directed to an information processing apparatus including a controller that is configured to perform: obtaining information about waste that is obtained by a sensor configured to detect the waste thrown into a trash can; obtaining information about a consumption behavior of a user from the information about the waste; and executing predetermined processing based on the information about the consumption behavior of the user. The information processing apparatus is, for example, a server. The controller is, for example, a processor such as a CPU (Central Processing Unit) or the like.

The waste thrown into the trash can has actually been consumed by the user, and hence, it is possible to obtain, from the waste, information about the consumption behavior of the user that matches the actual situation thereof. Thus, it is possible to provide a service corresponding to the consumption behavior of the user.

More specifically, a product or commodity corresponding to the waste may be given a code or RFID (Radio Frequency Identifier) tag including identification information of the product, The code including the identification information of the product is, for example, a bar code, a QR code (registered trademark), or the like. The RFID tag may be, for example, a seal attached to the product or embedded in a container of the product. The sensor may be a sensor that reads the identification information of the product from the code, or an RFID reader that reads the identification information of the product from the RFID tag, as the information about the waste. The sensor that reads the identification information of the product from the code is, for example, a barcode reader, a QR code (registered trademark) reader, or a camera. The sensor may be provided, for example, in the vicinity of an input port of the trash can.

The information about the waste may be information that is capable of identifying a first product corresponding to the waste. The information capable of identifying the first product is, for example, identification information or an image of the appearance of the first product. The controller may obtain a disposal amount of waste corresponding to the first product as the information about the consumption behavior of the user. As the predetermined processing, the controller may instruct the delivery of the first product to a place corresponding to an installation place of the trash can when the disposal amount of waste of the first product reaches a predetermined amount. As a result, for example, in cases where the trash can is installed in the user's home, when the predetermined amount of the first product is consumed, the first product is automatically delivered, so that the stock-out of the first product can be suppressed.

The information about the waste may be information capable of identifying the first product corresponding to the waste. The controller may obtain, as the information about the consumption behavior of the user, at least one of a disposal frequency and a disposal amount of the waste corresponding to the first product from the information about the waste in a predetermined period of time. In cases where the first product is a regular purchase product of the user, the controller may propose, as the predetermined processing, a change in at least one of an interval of shipping of the first product or an amount of shipping in one shipment thereof. The term “regular purchase” refers to a service in which a predetermined amount of product is shipped at a predetermined interval without the user having to place an order each time.

Thus, it is possible to flexibly change the shipping interval of the regular purchase or the shipping amount in one shipment according to a change in the amount of consumption or the frequency of use of the first product. For example, in cases where the first product is an item with a consumption date, such as food, it is possible to eliminate waste that the first product would be discarded without being fully consumed due to excessive shipping.

In addition, as the predetermined processing, the controller may propose a regular purchase of the first product, in cases where the disposal amount of the waste corresponding to the first product is equal to or greater than a predetermined amount and where the first product is not a regular purchase product of the user. The proposal for the regular purchase is made based on the actual consumption behavior of the user, so that the potential demand of the user can be satisfied.

In addition, the information about the waste may be information that is capable of identifying the product corresponding to the waste. The controller may obtain, as the information about the consumption behavior of the user, a disposal amount for each predetermined classification from the information about the waste in a predetermined period of time to obtain preference information of the user, and may propose, as the predetermined processing, a product corresponding to the preference information. Since the waste discarded in the trash can is actually consumed by the user, it reflects the preference information of the user. Thus, by proposing a product based on the user's preference information obtained from the waste information, the product that matches the user's preference is proposed. As a result, there is a high possibility that the proposal of the product leads to the purchase of the product. In addition, the user can save the trouble of searching for a product.

Hereinafter, embodiments of the present disclosure will be described based on the accompanying drawings. The configurations of the following embodiments are examples, and the present disclosure is not limited to the configurations of the embodiments.

### First Embodiment

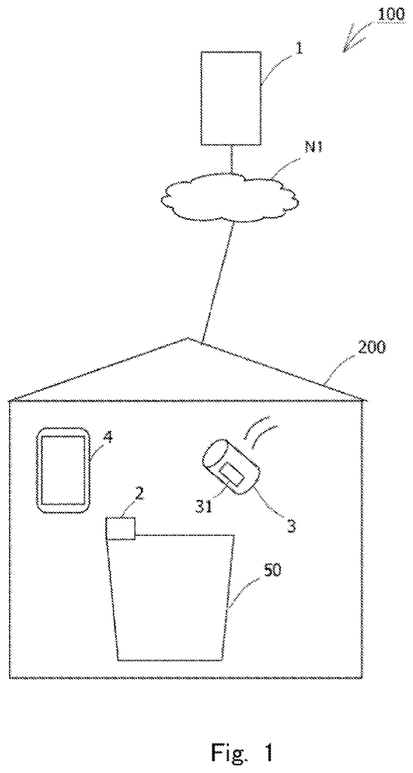

FIG. 1 is a diagram illustrating an example of a configuration of an automatic delivery system 100 according to a first embodiment. The automatic delivery system 100 is a system for automatically delivering a predetermined product in accordance with the consumption amount of the product. The automatic delivery system 100 includes a center server 1 and a sensor device 2 installed in a trash can 50. The trash can 50 is installed at a predetermined position in a user's home 200, for example.

The center server 1 is connected to a network N1. The network N1 is, for example, the Internet. However, the network N1 is not limited to the Internet. The sensor device 2 is capable of performing wireless communication, for example, and is connected to the network N1 by being wirelessly connected to a relay device in the user's home 200. The center server 1 and the sensor device 2 is capable of communicating with each other through the network N1.

The sensor device 2 is installed in the vicinity of a waste inlet or input port of the trash can 50. The sensor device 2 may be provided in advance in the trash can 50 and sold as an integral part, or may be in a form that can be retrofitted to the trash can 50 and sold separately as a single unit. The sensor device 2 is, for example, an RHO reader, a barcode reader, a OR code reader, or a camera. For example, in cases where the sensor device 2 is an RFI D reader, the sensor device 2 reads, upon an article 3 being put into the trash can 50, identification information of a product corresponding to the article 3 from an RHO tag 31, which includes the identification information of the corresponding product and is attached to the article 3. For example, in cases where the sensor device 2 is a barcode reader or a QR code (registered trademark) reader, the sensor device 2 reads a barcode or a OR code printed on the article 3 and obtains the identification information of the product corresponding to the article 3. Also, for example, in cases where the sensor device 2 is a camera, the sensor device 2 reads a barcode or a OR code printed on the article 3, or analyzes image data of the appearance of the article 3, thereby to obtain the identification information of the product corresponding to the article 3. Here, note that in the case where the sensor device 2 is a camera, the camera does not have to be installed in the vicinity of the input port of the trash can 50, but may be installed at a position around the trash can 50 such that the input port of the trash can 50 is included in an imaging range of the camera, In addition, the place where the trash can 50 is installed is not limited to the user's home 200, but may be, for example, an office or a predetermined facility. The home 200 is an example of “a place corresponding to an installation place of the trash can”.

Hereinafter, the article 3 thrown into the trash can 50 is referred to as waste 3, Also, detecting that the article 3 has been thrown into the trash can 50 is referred to as detection of the waste 3. Upon detecting the waste 3, the sensor device 2 transmits waste information about the waste 3 to the center server 1. The waste information includes, for example, the time when the waste 3 is detected, the identification information of the product corresponding to the waste 3, and the identification information of the sensor device 2, However, the waste information is not limited to this, but may also include identification information of the user.

The center server 1 collects the waste information from the sensor device 2, analyzes the waste information thus collected, and obtains consumption behavior information of the user. The consumption behavior information of the user is, for example, a disposal amount and a disposal frequency of the waste 3. The center server 1 delivers the product corresponding to the waste 3 to the user's home 200 based on the consumption behavior information of the user, proposes a change in the shipping interval of the regular or periodic purchase of the product corresponding to the waste 3 or a change in the shipping amount in one shipment, or proposes a regular purchase of the product corresponding to the waste 3.

For example, in the case where the article 3 is a beer can of product A, and when a predetermined number of beer cans of product A are thrown into the trash can, a predetermined number of beer cans of product A are automatically delivered to the home 200 of the user. Also, for example, in the case where the article 3 is a beer can of product B and the user has made a contract for the regular purchase of product B, when a change occurs in the disposal frequency or the disposal number of beer cans of product B in a predetermined period of time, a change in the shipping interval of the regular purchase of beer cans of product B or a change in the shipping amount in one shipment thereof is proposed. For example, in the case where the article 3 is a beer can of product C and the user has not made a contract for the regular purchase of product C, the regular purchase of product C may be proposed when the disposal amount of beer cans of product C in a predetermined period of time reaches a predetermined amount. Note that a proposal for such a regular purchase is transmitted from the center server 1 to the user terminal 4, for example.

According to the first embodiment, it is possible to provide a service of product delivery according to the consumption behavior of the user, by delivering the product corresponding to the waste 3, or proposing a change in the set content of a regular purchase, or proposing a regular purchase, according to the consumption behavior of the user.

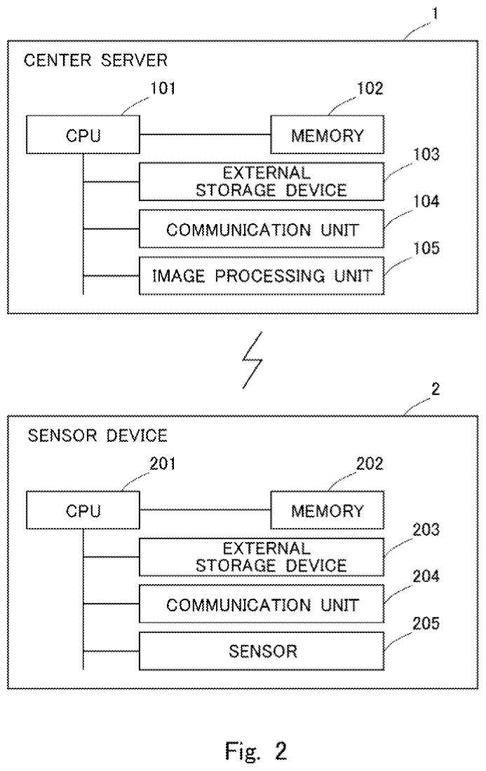

FIG. 2 is a diagram illustrating an example of a hardware configuration of the center server 1 and the sensor device 2 according to the first embodiment. The center server 1 includes, as a hardware configuration, a CPU (Central Processing Unit) 101, a memory 102, an external storage device 103, a communication unit 104, and an image processing unit 105. The memory 102 and the external storage device 103 are computer readable recording media. The center server 1 is an example of an “information processing apparatus”.

The external storage device 103 stores various programs and data to be used by the CPU 101 upon execution of each program. The external storage device 103 is, for example, an EPROM (Erasable Programmable ROM) and/or a hard disk drive. The programs held in the external storage device 103 include, for example, an operating system (OS), a control program of the automatic delivery system 100, and other various application programs. The control program of the automatic delivery system 100 is a program for controlling the delivery of products according to the consumption behavior of the user.

The memory 102 is a storage device which provides the CPU 101 with a storage area and a work area for loading programs stored in the external storage device 103, and which is used as a buffer. The memory 102 includes, for example, a semiconductor memory such as a ROM (Read Only Memory), a RAM (random access memory) or the like.

The CPU 101 executes various processes by loading the OS and various application programs held in the external storage device 103 into the memory 102 and executing them. The CPU 101 is not limited to one, but a plurality of CPUs may be provided. The CPU 101 is an example of a “controller”.

The communication unit 104 is an interface that inputs and outputs information to and from a network. The communication unit 104 is, for example, a LAN (Local Area Network) card. However, the communication unit 104 is not limited to this, but may be, for example, an ONU (Optical Network Unit) interface of an optical line.

The image processing unit 105 is, for example, a processor dedicated to image analysis. The image processing unit 105 performs predetermined recognition processing on input images, and outputs a recognition result to the CPU 101. Note that the hardware configuration of the center server 1 is not limited to that illustrated in FIG. 2.

The sensor device 2 includes, as its hardware configuration, a CPU 201, a memory 202, an external storage device 203, a communication unit 204, and a sensor 205. The CPU 201, the memory 202, and the external storage device 203 are similar to the CPU 101, the memory 102, and the external storage device 103, respectively.

The communication unit 204 is an interface that inputs and outputs information to and from a network. The communication unit 204 performs communications such as Wi-Fi or mobile communications such as LTE (Long Term Evolution), LTE-Advanced, 5G (5th Generation), etc., and connects to a public line network such as the Internet.

The sensor 205 is, for example, an RFID reader, a barcode reader, a OR code reader, or a camera. In the first embodiment, it is assumed that the sensor 205 is an RHO reader. The identification information of the product corresponding to the waste 3 obtained by the sensor 205 is outputted to the CPU 201, and further transmitted to the center server 1 through the communication unit 204 by means of the CPU 201. Note that the hardware configuration of the sensor device 2 is not limited to that illustrated in FIG. 2.

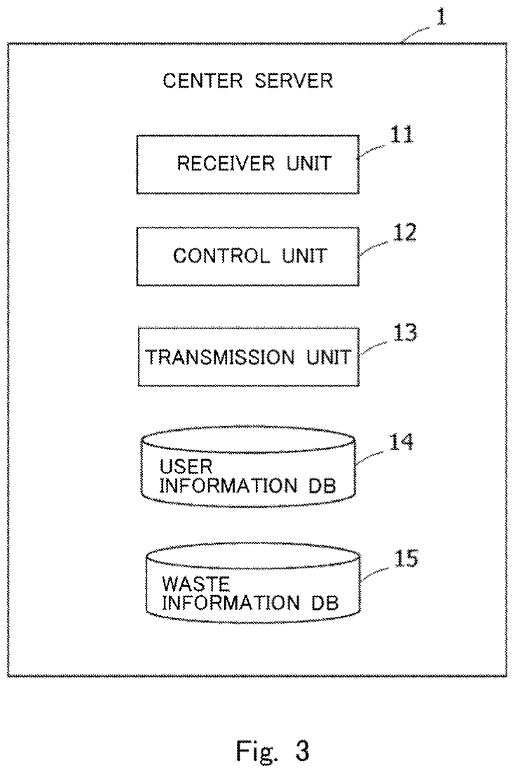

FIG. 3 is a diagram illustrating an example of a functional configuration of the center server 1. The center server 1 includes, as functional components, a receiver unit 11, a control unit 12, a transmission unit 13, a user information database (DB) 14, and a waste information DB 15. The receiver unit 11, the control unit 12, and the transmission unit 13 are achieved by the CPU 101 executing a predetermined program.

The receiver unit 11 receives waste information from the sensor device 2 through the network N1. The waste information thus received is outputted to the control unit 12. The transmission unit 13 transmits through the network N1 the information inputted from the control unit 12.

Upon receipt of the waste information from the receiver unit 11, the control unit 12 stores it in the waste information DB 15. In addition, the control unit 12 collects and analyzes waste information for a predetermined period of time for one user from the waste information DB 15, and obtains an analysis result as consumption behavior information of the user. The consumption behavior information of the user is, for example, a disposal amount and/or a disposal frequency of the product corresponding to the waste 3. The disposal frequency may be indicated by, for example, the number of times of disposal or the disposal amount of the waste 3 into the trash can 50 per unit such as a day, a week, or a month, or may be indicated by an average time of disposal intervals into the trash can 50.

Based on the consumption behavior information of the user, the control unit 12 makes an instruction to ship the product corresponding to the waste 3, a proposal to change the shipping interval or the shipping amount in one shipment of the regular purchase of the product corresponding to the waste 3, or a proposal for a regular purchase of the product corresponding to the waste 3. Details of these processing will be described later.

The user information DB 14 and the waste information DB 15 are created in the storage area of the external storage device 103. The user information DB 14 stores information about the user. The waste information DB 15 stores the waste information received from the sensor device 2. Details of the information stored in the user information DB 14 and the waste information DB 15 will be described later.

The functional configuration of the center server 1 illustrated in FIG. 3 is only an example, and the functional configuration of the center server 1 is not limited to that illustrated in FIG. 3.

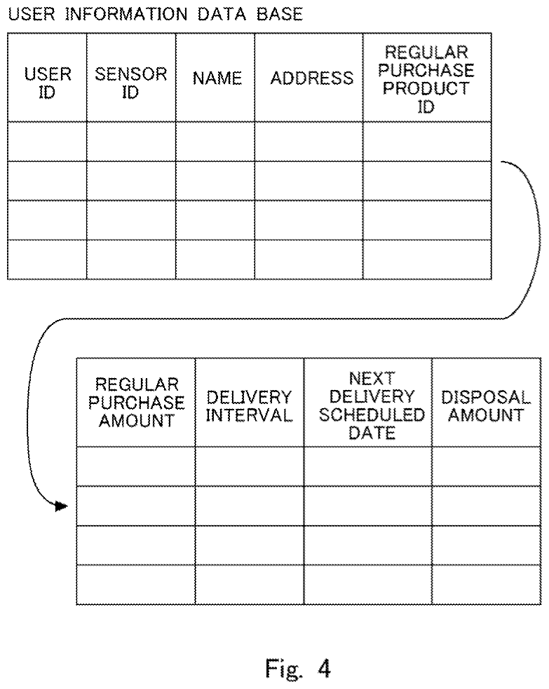

FIG. 4 illustrates an example of the information stored in the user information DB 14. One record of the user information DB 14 includes fields of a user ID, a sensor ID, a name, an address, a regular purchase product ID, a regular purchase amount, a shipping interval, a next scheduled shipping date, and a disposal amount.

The field of the user ID stores identification information of a user registered in the service of the automatic delivery system 100. The field of the sensor ID stores identification information of a sensor device 2. The fields of the name and address store the name and address of the user, respectively. The value in the field of the address is an address to which the regular purchase product is to be delivered. The address indicated by the value in the field of the address is an address including the location (installation place) of the trash can 50. This is because the place where the trash can 50 is installed is a place where the product is consumed and where there is a demand for the product.

The field of the regular purchase product ID stores identification information of a product for regular purchase with which the user has contracted. The field of the regular purchase amount stores a shipping amount of the product in one shipment designated by the user. The field of the shipping interval stores a shipping interval of the product for regular purchase designated by the user. The field of the next scheduled shipping date stores a scheduled date on which the product for regular purchase will be shipped next time. The field of the disposal amount stores a disposal amount of the product for regular purchase at the user's home 200. The fields of the regular purchase ID, the regular purchase amount, the shipping interval, the next scheduled shipping date, and the disposal amount are all empty in cases where there is no product for which the user has a contract for regular purchase.

For example, when waste information matching the value in the field of the regular purchase ID is received, the field of the disposal amount is incremented by the disposal amount by means of the control unit 12. In addition, for example, when the product for regular purchase is shipped, the field of the disposal amount is reset by the control unit 12.

The user information DB 14 is referred to by the control unit 12, for example, at the time of proposing whether or not the regular purchase product can be shipped, proposing a change in the shipping interval of the regular purchase or the shipping amount in one shipment, and proposing the regular purchase. Note that the information held in the user information DB 14 is not limited to that illustrated in FIG. 4.

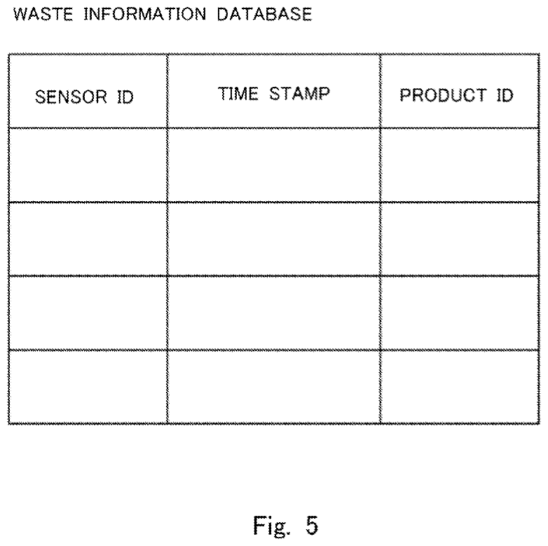

FIG. 5 is a diagram illustrating an example of the information held in the waste information DB 15. The waste information DB 15 holds the waste information received from the sensor device 2. One record of the waste information DB 15 includes fields of a sensor ID, a time stamp, and a product ID.

The sensor ID stores identification information of the sensor device 2. The field of the time stamp stores the point in time at which the waste 3 of the waste information was detected. The field of the product ID stores identification information of the product corresponding to the waste 3. Note that the information included in the waste information DB 15 is not limited to the information illustrated in FIG. 5.

### Flow of Processing

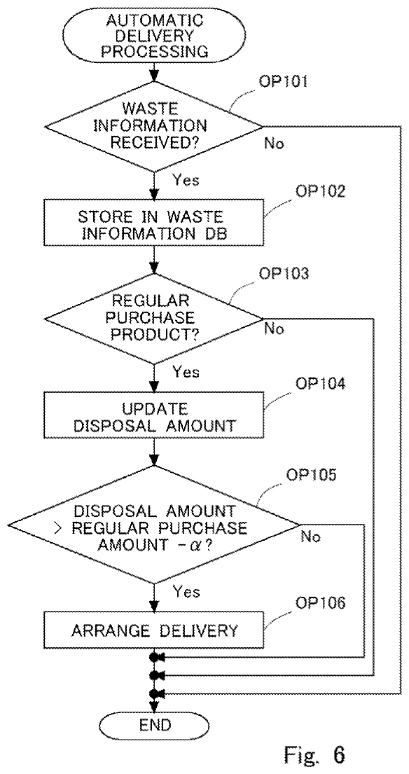

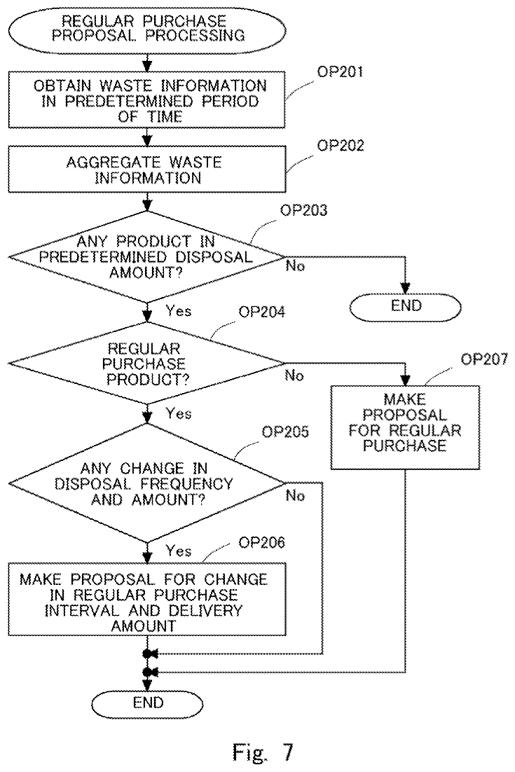

FIG. 6 is an example of a flowchart of automatic delivery processing of the center server 1. The automatic delivery processing is the processing of shipping a product based on the consumption behavior information of a user. The processing illustrated in FIG. 6 is repeatedly executed at a predetermined cycle. Although the CPU 101 is the main executor of the processing illustrated in FIG. 6, for the sake of convenience, the following description will be made mainly in terms of its functional configuration. The same applies to FIG. 7.

In OP101, the control unit 12 determines whether or not waste information has been received. When the waste information has been received (OP101: YES), the processing proceeds to OP102. When the waste information has not been received (OP101: NO), the processing illustrated in FIG. 6 ends.

In OP102, the control unit 12 stores the waste information thus received in the waste information DB 15. In OP103, the control unit 12 determines whether or not the received waste information is a product for which the corresponding user has made a contract for regular purchase. In OP103, the control unit 12 makes a determination by referring to the user information DB 14. When the received waste information is a product for which the corresponding user has made a contract for regular purchase (OP103: YES), the processing proceeds to OP104. On the other hand, when the received waste information is not a product for which the corresponding user has a contract for regular purchase (OP103: NO), the processing illustrated in FIG. 6 ends.

In OP104, the control unit 12 updates the value in the field of the disposal amount of a record of the user information DB 14 in which the identification information of the sensor included in the received waste information and the identification information of the product corresponding to the waste 3 match the values in the fields of the sensor ID and the regular purchase product ID, respectively. For example, in cases where the product corresponding to the waste 3 indicated by the waste information and the product indicated by the regular purchase product ID indicate a predetermined amount of canned beer, the value in the field of the disposal amount is updated by adding 1 each time one piece of waste information is received. The disposal amount of the regular purchase product is an example of the consumption behavior information of the user.

In OP105, the control unit 12 determines whether or not the disposal amount of the regular purchase product of the user is greater than a regular purchase amount-α. When the disposal amount of the regular purchase product of the user is greater than the regular purchase amount-α (OP105: YES), the processing proceeds to OP106. When the disposal amount of the regular purchase product of the user is equal to or less than the regular purchase amount-α (OP105: NO), the processing illustrated in FIG. 6 ends. The regular purchase amount-α is an example of a “predetermined amount”. Note that the threshold used in OP105 is not limited to this.

In OP106, the control unit 12 arranges for the delivery of the regular purchase product to the user's home 200. For example, the control unit 12 may request the delivery of the regular purchase product to a store designated by the user in advance, or may request the delivery of the regular purchase product to a store with the lowest price among a plurality of stores. The amount of the product to be shipped may be, for example, an amount specified in the field of the regular purchase amount of the corresponding record of the user information DB 14, or may be an amount equivalent to the actual disposal amount. Thereafter, the processing illustrated in FIG. 6 ends.

FIG. 7 is an example of a flowchart of regular purchase proposal processing of the center server 1. The regular purchase proposal processing is the processing of making a proposal regarding a regular purchase based on the consumption behavior information of the user. The processing illustrated in FIG. 7 is repeatedly executed at a predetermined cycle such as a week, a month or the like. The processing illustrated in FIG. 7 is performed for each user.

In OP201, the control unit 12 obtains, from the waste information DB 15, waste information of a target user in a predetermined period of time, The period of time during which the waste information is collected may be, for example, the same as or different from the shipping interval of the regular purchase product. In OP202, the control unit 12 aggregates the waste information obtained in OP201 for each predetermined classification or category. The classification of the waste information is performed by, for example, any one of a product, a type of a product, and a manufacturer of a product. However, the classification is not limited to this. In OP202, a disposal amount, a disposal frequency and the like for each classification are obtained as a result of the aggregation of the waste information. The aggregate result of the waste information obtained in OP202 is an example of the consumption behavior information of the user.

In OP203, the control unit 12 determines whether or not there is a product with its disposal amount equal to or greater than the predetermined amount. The determination in OP203 may be replaced, for example, by determining whether or not the number of pieces of waste information is equal to or greater than a predetermined number, In cases where there is a product whose disposal amount is equal to or greater than the predetermined amount (OP203: YES), the processing proceeds to OP204. In cases where there is no product whose disposal amount is equal to or greater than the predetermined amount (OP203: NO), the processing illustrated in FIG. 7 ends.

In OP204, it is determined whether or not the product detected in OP203 is a regular purchase product of the target user. The processing in OP204 is performed with reference to the user information DB 14. When the product detected in OP203 is a regular purchase product of the target user (OP204: YES), the processing proceeds to OP205. On the other hand, when the product detected in OP203 is not a regular purchase product of the target user (OP204: NO), the processing proceeds to OP207, and in OP207, the control unit 12 transmits a proposal for regular purchase of the product detected in OP203 to the user terminal 4 through the transmission unit 13. The proposal for the regular purchase may be made, for example, by transmission of an electronic mail or by push distribution. In addition to the proposal for the regular purchase, proposals for the shipping interval and the shipping amount in one shipment may also be transmitted based on the aggregation result obtained in OP202. Thereafter, the processing illustrated in FIG. 7 ends.

In OP205, the control unit 12 determines whether or not there is a change in the disposal frequency and the disposal amount of the regular purchase product obtained in OP202. The determination in OP205 may be made, for example, by determining whether or not the disposal frequency and the disposal amount of the regular purchase product obtained in OP202 are deviated by a predetermined value or more from the shipping interval and the shipping amount per shipment of the corresponding record in the user information DB 14. Alternatively, for each execution of the regular purchase proposal processing, the disposal frequency and the disposal amount of the regular purchase product obtained in OP202 may be recorded, and the determination may be made based on whether or not there is a change of a predetermined value or more from the previous value.

When there is a change in the disposal frequency and the disposal amount of the regular purchase product obtained in OP202 (OP205: YES), the processing proceeds to OP206. On the other hand, when there is no change in the disposal frequency and the disposal amount of the regular purchase product obtained in OP202 (OP205: NO), the processing illustrated in FIG. 7 ends.

In OP206, the control unit 12 transmits, to the user terminal 4 via the transmission unit 13, a proposal for changing the shipping interval and/or the shipping amount in one shipment of the regular purchase product. The proposal may be made, for example, by transmission of an electronic mail or push distribution. Proposals for the shipping interval and the shipping amount in one shipment may also be transmitted based on the aggregation result obtained in OP202. Thereafter, the processing illustrated in FIG. 7 ends.

### Effects of the First Embodiment

In the first embodiment, the sensor device 2 detects the waste 3 thrown into the trash can 50 to obtain waste information, and the center server 1 obtains consumption behavior information of the user from the waste information. The center server 1 performs processing according to the consumption behavior information of the user. Thus, it is possible to provide a service corresponding to the consumption behavior information of the user.

In the first embodiment, the disposal amount of waste for one product is monitored based on the waste information, so that when the disposal amount of the waste reaches a predetermined amount (or number), the product is delivered to the user's home 200 in an automatic manner. As a result, it is possible to replenish the inventory of the product without having to place an order at a timing when the product is about to run out. In addition, in the first embodiment, the center server 1 is not tied or linked to a specific store or sales site, and can select a purchase destination from among a plurality of stores and sales sites.

In the first embodiment, the disposal frequency and the disposal amount for one product are obtained based on the waste information thereof, and a proposal for the regular purchase of the product or a proposal for a change in the shipping interval of the regular purchase of the product or the shipping amount in one shipment of the product is made according to the disposal frequency and the disposal amount. As a result, it is possible to make a proposal for the regular purchase based on the tendency of the product actually consumed by the user. In addition, in cases where the proposal for the regular purchase of the product is made, the potential demand of the user can be picked up, and the sales of the product can be increased. Also, in cases where the proposal is made to change the shipping interval of the regular purchase of the product or the shipping amount in one shipment of the product, the shipping interval and the shipping amount of the regular purchase can be adjusted according to a change in the consumption amount or the consumption frequency due to the season, changes in family composition, or the like.

### Other Embodiments

The above-described embodiment is merely an example, but the present disclosure can be implemented with appropriate modifications without departing from the spirit thereof.

The consumption behavior information of the user obtained by analyzing the waste information can also be regarded as preference information that reflects the preference of the user. Since the waste information is not related to a sales site, a sales shop, or the like, the preference information obtained from the waste information more accurately reflects the preference of the user. The preference information obtained from the waste information is, for example, information indicating the product, the type of the product, the manufacturing company of the product, or the like in which the disposal amount of waste in a predetermined period of time is equal to or greater than the predetermined number or a predetermined threshold value. By using such preference information, the center server 1 can provide, for example, information about a new product more compatible with the preference information of the user. For example, when the preference information of the user indicates that the disposal amount of beer for product E of manufacturer D is large, the center server 1 transmits information about new product F of beer of the manufacturer D to the user terminal 4.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner.

The present disclosure can also be realized by supplying to a computer a computer program in which the functions described in the above-described embodiment are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
obtaining information about waste that is obtained by a sensor configured to detect the waste thrown into a trash can;
obtaining information about a consumption behavior of a user from the information about the waste; and
executing predetermined processing based on the information about the consumption behavior of the user.

2. The information processing apparatus according to claim 1, wherein
the information about the waste is information capable of identifying a first product corresponding to the waste; and
the controller is configured to perform:
obtaining a disposal amount of waste corresponding to the first product as the information about the consumption behavior of the user; and
making, as the predetermined processing, an instruction to deliver the first product to a place corresponding to an installation place of the trash can, when the disposal amount of waste corresponding to the first product reaches a predetermined amount.

3. The information processing apparatus according to claim 1, wherein
the information about the waste is information capable of identifying a first product corresponding to the waste; and
the controller is configured to perform:
obtaining, as the information about the consumption behavior of the user, at least one of a disposal frequency and a disposal amount of waste corresponding to the first product from the information about the waste in a predetermined period of time; and
making, as the predetermined processing, a proposal to change at least one of a shipping interval of the first product or a shipping amount in one shipment thereof in cases where the first product is a regular purchase product of the user.

4. The information processing apparatus according to claim 1, wherein
the information about the waste is information capable of identifying a first product corresponding to the waste; and
the controller is configured to perform:
obtaining, as the information about the consumption behavior of the user, a disposal amount of waste corresponding to the first product from the information about the waste in a predetermined period of time; and
making, as the predetermined processing, a proposal for regular purchase of the first product, in cases where a disposal amount of waste corresponding to the first product is equal to or greater than a predetermined amount and where the first product is not a regular purchase product of the user.

5. The information processing apparatus according to claim 1, wherein
the information about the waste is information capable of identifying a product corresponding to the waste; and
the controller is configured to perform:
obtaining, as the information about the consumption behavior of the user, a disposal amount for each predetermined classification from the information about the waste in a predetermined period of time to obtain preference information of the user; and
making, as the predetermined processing, a proposal for a product corresponding to the preference information.

6. The information processing apparatus according to claim 1, wherein
a code including identification information of a product is attached to the product corresponding to the waste; and
the sensor is a sensor that reads, as the information about the waste, the identification information of the product from the code.

7. The information processing apparatus according to claim 1, wherein
an RFID (Radio Frequency Identifier) tag including identification information of the product is attached to the product corresponding to the waste; and
the sensor is a reader that reads the identification information of the product from the RFID tag as the information about the waste.

8. An information processing system comprising:
a sensor configured to detect waste thrown into a trash can;
an information processing apparatus including a controller configured to perform:
obtaining information about the waste obtained by the sensor;
obtaining information about a consumption behavior of a user from the information about the waste; and
executing predetermined processing based on the information about the consumption behavior of the user.

9. The information processing system according to claim 8, wherein
the information about the waste is information capable of identifying a first product corresponding to the waste; and
the controller is configured to perform:
obtaining a disposal amount of waste corresponding to the first product as the information about the consumption behavior of the user; and
making, as the predetermined processing, an instruction to deliver the first product to a place corresponding to an installation place of the trash can, when the disposal amount of waste corresponding to the first product reaches a predetermined amount.

10. The information processing system according to claim 8, wherein
the information about the waste is information capable of identifying a first product corresponding to the waste; and
the controller is configured to perform:
obtaining, as the information about the consumption behavior of the user, at least one of a disposal frequency and a disposal amount of waste corresponding to the first product from the information about the waste in a predetermined period of time; and
making, as the predetermined processing, a proposal to change at least one of a shipping interval of the first product or a shipping amount in one shipment thereof in cases where the first product is a regular purchase product of the user.

11. The information processing system according to claim 8, wherein
the information about the waste is information capable of identifying a first product corresponding to the waste; and
the controller is configured to perform:
obtaining, as the information about the consumption behavior of the user, a disposal amount of waste corresponding to the first product from the information about the waste in a predetermined period of time; and
making, as the predetermined processing, a proposal for regular purchase of the first product, in cases where the disposal amount of waste corresponding to the first product is equal to or greater than a predetermined amount and where the first product is not a regular purchase product of the user.

12. The information processing system according to claim 8, wherein
the information about the waste is information capable of identifying a product corresponding to the waste; and
the controller is configured to perform:
obtaining, as the information about the consumption behavior of the user, a disposal amount for each predetermined classification from the information about the waste in a predetermined period of time to obtain preference information of the user; and
making, as the predetermined processing, a proposal for a product corresponding to the preference information.

13. The information processing system according to claim 8, wherein
a code including identification information of a product is attached to the product corresponding to the waste; and
the sensor is a sensor that reads, as the information about the waste, the identification information of the product from the code.

14. The information processing system according to claim 8, wherein
an RFID (Radio Frequency Identifier) tag including identification information of a product is attached to the product corresponding to the waste; and
the sensor is a reader that reads the identification information of the product from the RFID tag as the information about the waste.

15. An information processing method comprising:
obtaining information about waste that is obtained by a sensor configured to detect the waste thrown into a trash can;
obtaining information about a consumption behavior of a user from the information about the waste; and
executing predetermined processing based on the information about the consumption behavior of the user.

16. The information processing method according to claim 15, wherein
the information about the waste is information capable of identifying a first product corresponding to the waste; and
the method further comprising: obtaining a disposal amount of waste corresponding to the first product as the information about the consumption behavior of the user; and
making, as the predetermined processing, an instruction to deliver the first product to a place corresponding to an installation place of the trash can, when the disposal amount of waste corresponding to the first product reaches a predetermined amount.

17. The information processing method according to claim 15, wherein
the information about the waste is information capable of identifying a first product corresponding to the waste; and
the method further comprising: obtaining, as the information about the consumption behavior of the user, at least one of a disposal frequency and a disposal amount of waste corresponding to the first product from the information about the waste in a predetermined period of time; and
making, as the predetermined processing, a proposal to change at least one of a shipping interval of the first product or a shipping amount in one shipment thereof in cases where the first product is a regular purchase product of the user.

18. The information processing method according to claim 15, wherein
the information about the waste is information capable of identifying a first product corresponding to the waste; and
the method further comprising: obtaining, as the information about the consumption behavior of the user, a disposal amount of waste corresponding to the first product from the information about the waste in a predetermined period of time; and
making, as the predetermined processing, a proposal for regular purchase of the first product, in cases where a disposal amount of waste corresponding to the first product is equal to or greater than a predetermined amount and where the first product is not a regular purchase product of the user.

19. The information processing method according to claim 15, wherein
the information about the waste is information capable of identifying a product corresponding to the waste; and
the method further comprising: obtaining, as the information about the consumption behavior of the user, a disposal amount for each predetermined classification from the information about the waste in a predetermined period of time to obtain preference information of the user; and
making, as the predetermined processing, a proposal for a product corresponding to the preference information.

20. The information processing method according to claim 15, wherein
an RFID (Radio Frequency Identifier) tag including identification information of the product is attached to the product corresponding to the waste; and
the sensor is a reader that reads the identification information of the product from the RFID tag as the information about the waste.
